(19) United States
(12) Patent Application Publication
(10) Pub. No.: US 2002/0128878 A1
(43) Pub. Date: Sep. 12, 2002

(54) Method and apparatus for consolidating billing information and paying suppliers on a network

(76) Inventors: L. Michael Maritzen, Fremont, CA (US); Kiyohiko Niwa, Haworth, NJ (US); Yoshihiro Tsukamura, Cresskill, NJ (US); Harold Aaron Ludtke, San Jose, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/930,609

(22) Filed: Aug. 15, 2001

Related U.S. Application Data
(60) Provisional application No. 60/229,612, filed on Aug. 31, 2000.
(60) Provisional application No. 60/254,501, filed on Dec. 8, 2000.

(51) Int. Cl. G06F 17/60

(52) U.S. Cl. 705/4

(57) ABSTRACT

Transaction information from more than one supplier on a network-enabled portal is consolidated by a consolidation payment service and a user provides payment information to the consolidation payment service a single time to pay the suppliers. A consolidation payment service receives a first transaction data from a first supplier located on a network-enabled portal. The consolidation payment service receives a second transaction data from a second supplier located on the network-enabled portal. The consolidation payment service consolidates the first transaction data and the second transaction data. The consolidation payment service receives payment information a single time from a user to pay the first supplier and the second supplier. The user is presented with a single transaction history that includes the first transaction data and the second transaction data.

This application claims the benefit of the earlier filing date of co-pending provisional application of L. Michael Maritzen, Kiyo Niwa, Yoshihiro Tsukamura, and Harold Aaron Ludtke entitled, “Method and Apparatus for A Billing and Payment Consolidation Model for Internet-Enabled Portals,” Ser. No. 60/229,612, filed Aug. 31, 2000 and incorporated herein by reference.

This application also claims the benefit of the earlier filing date of co-pending provisional application of L. Michael Maritzen, Kiyo Niwa, Yoshihiro Tsukamura, and Harold Aaron Ludtke entitled, “Method and Apparatus for A Billing and Payment Consolidation Model for Internet-Enabled Portals,” Ser. No. 60/254,501, filed Dec. 8, 2000 and incorporated herein by reference.

### BACKGROUND OF THE INVENTION

1. Field of the Invention

The invention relates generally to processing billing information and paying bills from different networked suppliers. More specifically, the invention relates to reuse of financial information to process billing information and pay multiple bills from multiple networked suppliers.

2. Background

Mall-style portals, located on a network such as the Internet, are becoming increasingly popular for the purchase of products or services from suppliers. A user of a computer, for example, typically browses through web sites on the Internet and may go to XYZ.com, a mall that includes many suppliers such as Tower Records and CD Now. The user may then select a compact disc (CD) from CD Now and a video from Tower Records. The user provides credit card information to pay for the CD and the video in individual transactions. There are at least three disadvantages to this conventional approach. First, using a credit card to purchase a CD from CD Now and a video from Tower Records is time consuming because the user must repeatedly input the same information such as his or her credit card number, the expiration of the credit card, and any other applicable information for each individual transaction.

Second, the user may be presented with more than one invoice from each supplier such as CD Now and Tower Records which is in contravention of most users' preference to reduce the type of information they receive on transactions. Third, the user is required to reveal his or her identity to the supplier during the transaction even though the user may wish to remain anonymous. It is therefore desirable to have a system or a method that addresses the disadvantages associated with conventional methods and systems.

### SUMMARY

Transaction information from more than one supplier on a network-enabled portal is consolidated by a consolidation payment service and a user provides payment information to the consolidation payment service a single time to pay the suppliers. A consolidation payment service receives a first transaction data from a first supplier located on a network-enabled portal. The consolidation payment service receives a second transaction data from a second supplier located on the network-enabled portal. The consolidation payment service consolidates the first transaction data and the second transaction data. The consolidation payment service receives payment information a single time from a user to pay the first supplier and the second supplier. The user is presented with a single transaction history that includes the first transaction data and the second transaction data.

### BRIEF DESCRIPTION OF THE DRAWINGS

The present invention is illustrated by way of example and not limited in the figures of the accompanying drawings, in which like references indicate similar elements and in which:

FIG. 1 is a block diagram of one embodiment of a system configured to consolidate transaction information from more than one supplier and to provide payment information a single time for paying more than one supplier;

FIG. 2 is a block diagram of one embodiment of a secure transaction system;

FIG. 3 is a block diagram of one embodiment of a privacy card for a personal transaction device;

FIG. 4 is a block diagram of one embodiment of a digital wallet for a personal transaction device; and

FIG. 5 is a flow diagram of one embodiment for a method of consolidating more than one transaction and providing payment information a single time for paying more than one supplier.

### DETAILED DESCRIPTION

In the following description, numerous specific details are set forth to provide a thorough understanding of the invention. However, it will be understood by one of ordinary skill in the art that the invention may be practiced without these specific details. In other instances, well known structures and techniques have not been shown in detail to avoid obscuring the invention.

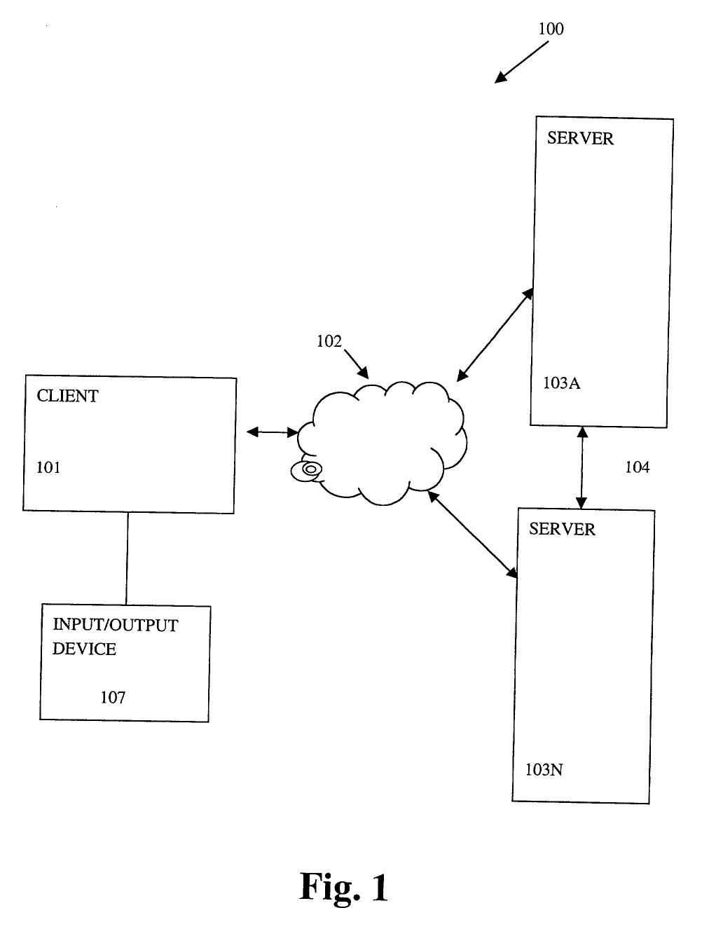

FIG. 1 illustrates a block diagram of one embodiment of system 100 that is used to purchase a product or a service in a transaction from more than one supplier at web sites operating on servers 103A-103N while payment information is supplied a single time from the user to a consolidation payment service which operates, for example, on server 103A. System 100 includes client 101 and conventional servers 103A-103N that are connected to network 102 such as the Internet or an intranet. To better understand aspects of the invention, transaction, product, and service are defined but it will be appreciated that the claimed invention is not limited by these definitions. A transaction is a completion of an act (or acts) such as that which is involved in purchasing a product or a service in a business deal. A product is a good as defined under the Uniform Commercial Code (UCC §2-105) or other suitable item. Service, on the other hand, is defined as a duty or as labor to be rendered by one person to another. A supplier is an entity that offers a good or a service in exchange for something of value such as money.

To illustrate techniques of the invention, an example is presented regarding the purchase of products from two suppliers over a network-enabled portal. A network-enabled portal is a web site (e.g., YAHOO! ®SHOPPING) that is a “doorway” to the World Wide Web that typically presents numerous hyperlinks to useful web pages of suppliers that offer products or services. For example, some of the hyperlinks to suppliers may include Barnes&Noble.com, a supplier of books, Dell.com, a supplier of computers and a variety of other suppliers.

By using, for instance, input/output device 107 such as a mouse connected to client 101, the user selects the hyperlink to Barnes&Noble.com in order to purchase a book concerning electrical circuits. The user selects the book, places the book into a shopping cart, and orders the book from the supplier by indicating that he would like to purchase the book. As soon as the user indicates that he or she has ordered a product or a service, transaction data is generated at the supplier. Instead of providing payment information upon checking out from Barnes&Noble.com, which operates on server 103N, the transaction data related to the purchase of the book is sent from server 103N on interconnect 104 to server 103A where the consolidation payment service is executed.

The user then exits Barnes&Noble.com, returns to YAHOO!SHOPPING, and selects the hyperlink to Dell.com to purchase a computer. The user selects the computer he wishes to purchase, places the computer into a shopping cart, and orders the computer. In one embodiment, the transaction data is transferred to the network-enabled portal that is configured to perform the function of the consolidation payment service. In an alternate embodiment, the transaction data related to the purchase of the computer is sent on interconnect 104 to the consolidation payment service operating on server 103A. Thereafter, the user returns to the network-enabled portal (e.g., YAHOO!SHOPPING) and indicates to the consolidation payment service that he has completed his shopping at the network-enabled portal. This may be accomplished by, for example, the user selecting an icon that states “shopping completed at the mall.”

Once this icon is selected, several actions occur. The transaction data from the purchase of the book and the computer is consolidated, and the prices are totaled (and taxed if required) at the consolidation payment service. Each of these actions is described below.

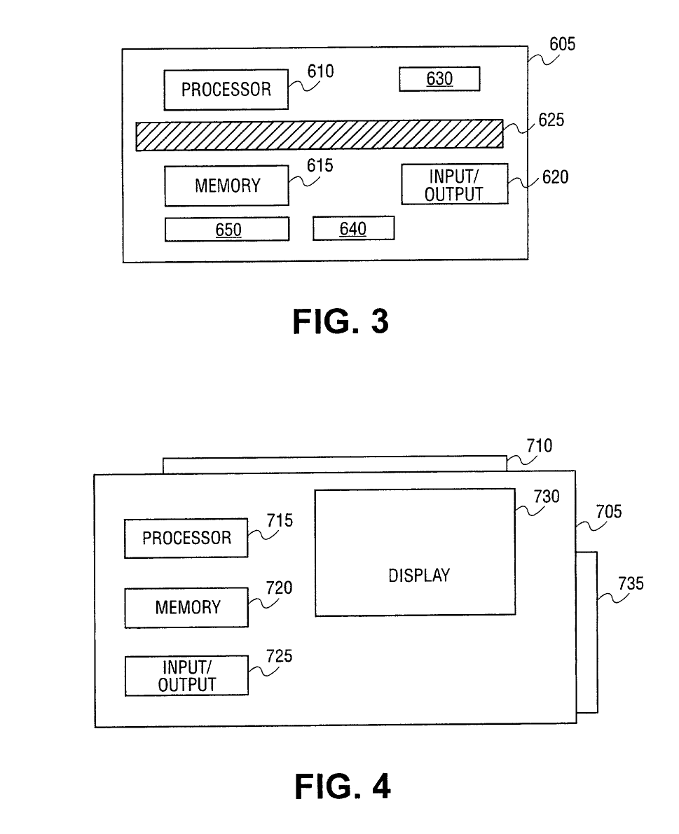

In one embodiment, consolidating transaction data involves linking the two transactions. Information that may be used to link transaction data includes the user's name, social security card number, credit card number, or other suitable information. In another embodiment, the two transactions are linked through a unique number which may be associated with, for example, a transaction device described in FIGS. 3-4 that authorizes a transaction without revealing the identity of the user.

Table 1, provided below, illustrates one example of a single transaction history. After the two example transactions have been consolidated, the prices for the products are added and the sales tax calculated. This single transaction history, that is eventually presented to the user electronically through a graphical user interface or through a printer coupled to client 101, serves the purpose of summarizing the transactions that occurred at the network-enabled portal. The two transactions, linked by the user's social security number, may be summarized as follows:

TABLE 1
Transaction History For John Smith on August 1, 2001 at the
Network-enabled Portal

| Social | | | | | | Total Cost |
|---|---|---|---|---|---|---|
| Security | Item | Number of | Cost | Taxes | Discount | Including |
| Number | Description | Item | ($) | ($) | ($) | Taxes ($) |
| 400-00-0000 | | | | | | |
| First | Electrical | ISBN | 80 | 4 | 0 | 84 |
| Supplier | Circuits | 0471386898 | | | | |
| (Barnes & | Book | | | | | |
| Noble) | | | | | | |
| Second | Computer | Inspiron | 2,500 | 125 | 0 | 2625 |
| Supplier | | 8000 | | | | |
| (Dell) | | | | | | |
| Total | | | 2,580 | 129 | 0 | 2,709 |
| Total | | | | | | 84 |
| Funds (or | | | | | | |
| Credit) | | | | | | |
| Transferred | | | | | | |
| To The | | | | | | |
| First | | | | | | |
| Supplier | | | | | | |
| Total | | | | | | 2625 |
| Funds (or | | | | | | |
| Credit) | | | | | | |
| Transferred | | | | | | |
| To The | | | | | | |
| First | | | | | | |
| Supplier | | | | | | |

The total amount for the purchases shown on the transaction history is charged to the user through, for example, using information from a conventional credit card, a transaction device, or other suitable means. The user provides this financial information a single time to the consolidation payment service in order to pay for both transactions. This makes the user's shopping experience on the Internet much more enjoyable especially during holiday shopping since payment information is provided once for multiple purchases from several suppliers. Information that may be inputted a single time by the user to pay for the products typically includes the user's name, the address to which the product is to be delivered, the telephone number in which the user may be contacted, his or her credit card number, the expiration date of the card, or any other pertinent information. In comparison, conventional electronic commerce systems require that the user provide this same type of information to both suppliers in order to purchase both items.

In one embodiment, the consolidation payment service is configured to properly send the correct amount of funds (or credit for funds) to the correct supplier. In the example presented above, Barnes & Noble would electronically receive funds from the user's account that amount to $84 whereas Dell would electronically receive funds that amount to $2,625.

In another aspect of the invention, the consolidation payment service is configured to partition and provide funds to the original suppliers of the products and the distributors of the products. For instance, songs may be purchased and downloaded from the Internet. Assume, for illustrative purposes, that Sony owns a song and royalties are paid to the author and the singer of the song. When this song is purchased and downloaded from the Internet, the consolidation payment service is configured to distribute funds (or credit for funds) to Sony, the author of the song, and to the singer of the song. To properly partition the funds, the consolidation payment service must be provided with the legal rights (also referred to herein as the digital payment right policy) associated with the song in terms of, for example, distribution of funds. In this example, assume that the song costs $1.00 and the digital payment right policy associated with the song indicates that Sony receives ninety-three percent of the proceeds, the singer is to receive six percent of the proceeds, and the author of the song is to receive one percent of the proceeds. The consolidation payment service would ensure that Sony receives ninety-three cents credit, the singer receives six cents credit, and the author of the song receives one penny. The singer and the author of the song receive the money due much faster (e.g., real-time) than conventional methods pay them such as over six months.

To participate in the consolidation payment service suppliers, may agree to uniform policies. For example, one policy may encourage suppliers to share information with other suppliers that may reduce the price of the products to the user. For instance, if the user purchases a service such as an airline ticket from Southwest Airlines, he may receive a reduction in cost to rent a car from Hertz. Under this policy, when the user completes his shopping at the network-enabled portal, the consolidation payment service begins to tally the cost of the products and services. It would then recognize that since the user purchased an airline ticket from Southwest Airlines, the user should be granted a discount on the rental of his car from Hertz. The discount on the rental car would automatically be applied to the rental car fee by the consolidation payment service implementing the policy agreement.

In another aspect, a supplier may designate the type and the amount of information that is revealed to another supplier. To illustrate, a supplier may desire to maintain the price of his or her product or service in confidence such that the price is not disclosed to another supplier. Accordingly, pricing information may not be revealed to another supplier. Alternatively, some suppliers may find it desirable to share pricing information with other suppliers such as in competitive pricing situations. Other policies that may be applicable to each supplier include uniform security measures (e.g. prevent third parties from accessing confidential information), customer service policies (e.g., dispute resolution agreements for resolving a dispute that arises with a customer) or other suitable policies.

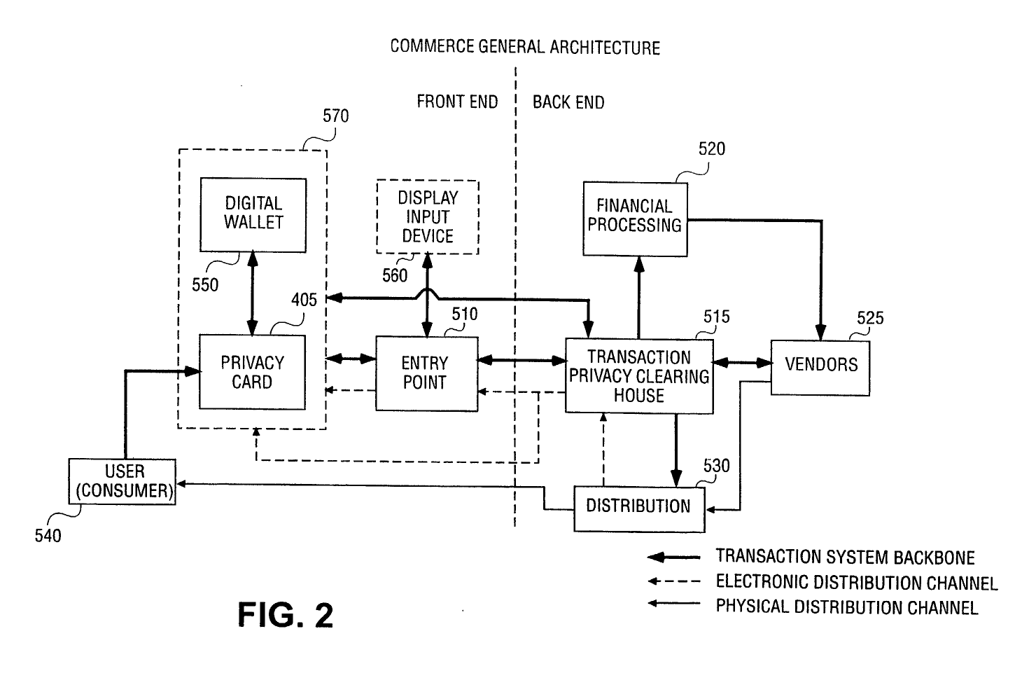

In another embodiment, the user may wish to prevent disclosure of his identity to a supplier by using a secure transaction system. FIG. 2 is a block diagram of one embodiment of a secure transaction system, which may be used in electronic commerce. In this embodiment, a transaction privacy clearing house (TPCH) 515 may be used to interface the user (or consumer) 540 with vendor (supplier) 525 along with the consolidation payment service described with respect to FIG. 1. In this particular embodiment, a personal transaction device (PTD) 570, e.g., privacy card 405, or privacy card 405 coupled to digital wallet 550, is used to maintain the privacy of the user while enabling the user to perform transactions. In an alternate embodiment, PTD 570 may be any suitable device that allows unrestricted access to TPCH 515. For example, PTD 570 may include instruction logic implemented in a card (smart card) hand-held device or computer system of the user. PTD 570 information is provided to TPCH 515 that then indicates to vendor 525 and user 540 approval of the transaction to be performed.

In order to maintain confidentiality of the identity of user 540, the transaction device information does not provide user identification information. Thus, vendor 525 or other entities do not have user information. Instead, vendor 525 receives transaction device information. TPCH 515 maintains a secure database of transaction device information and user information. In one embodiment, financial information such as a credit card account and billing name and address is provided by user 540 to PTD 570. PTD 570 provides the financial information, exclusive of the user name and/or billing address to TPCH 515. TPCH 515 interfaces to at least one financial processing system 520 to perform associated financial transactions, such as confirming sufficient funds to perform the transaction, and transfers to vendor 525 the fees required to complete the transaction. In addition, TPCH 515 may also provide information through distribution function 530 that, in one embodiment, can provide a purchased product to user 540, again without vendor 525 knowing the identification of user 540. In an alternate embodiment, financial processing system 520 need not be a separate entity but may be incorporated with other functionality. For example, in one embodiment, financial processing system 520 may be combined with TPCH 515 functionality.

In one embodiment, financial processing system 520 performs tasks of transferring funds between the user's account and the vendor's account for each transaction. In one embodiment, the presence of TPCH 515 means that no details of the transactions, other than the amount of the transactions and other basic information (such as an account number), are known to financial processing system 520. TPCH 515 issues transaction authorizations to financial processing system 520 function on an anonymous basis on behalf of the user over a highly secure channel. Financial processing system 520 does not need to have many electronic channels receiving requests for fund transfer, as in a traditional financial processing system. In one embodiment, a highly secure channel is set up between TPCH 515 and financial processing system 520; thus, financial processing system 520 is less vulnerable to spoofing.

In one embodiment, financial processing system 520 is contacted by TPCH 515 requesting a generic credit approval of a particular account. Thus, financial processing system 520 receives a minimal amount of information. In one embodiment, the transaction information, including the identification of goods being purchased with the credit need not be passed to financial processing system 520. TPCH 515 can request the credit using a dummy charge ID that can be listed in the monthly credit statement sent to the user, so that the user can reconcile his credit statement. Further, PTD 570 can include functionality to cause the credit statement to convert the dummy charge ID back to the transactional information so that the credit statement appears to be a conventional statement that lists the goods that were purchased and the associated amount charged.

Display input device 560 (shown in phantom) may be included to enable the user, or in some embodiments vendor 525, to display status and provide input regarding PTD 570 and the status of the transaction to be performed.

In yet another embodiment, entry point 510 interfaces with PTD 570 and also communicates with TPCH 515. Entry point 510 may be an existing (referred to herein as a legacy point of sale (POS) terminal) or a newly configured POS terminal located in a retail environment. User 540 uses PTD 570 to interface to the POS terminal in a manner similar to how credit cards and debit cards interface with POS terminals. Entry point 510 may also be a public kiosk, a personal computer, or the like.

The system described herein may also provide distribution function 530 whereby products purchased via the system are distributed. In one embodiment, distribution function 530 is integrated with TPCH 515 functionality. In an alternate embodiment, distribution function 530 may be handled separate from TPCH 515. Utilizing either approach, the system ensures user privacy and data security. Distribution function 530 interacts with the user through PTD 570 to ship the product to the appropriate location. A variety of distribution systems are contemplated, for example, electronic distribution through a POS terminal coupled to the network, electronic distribution direct to one or more privacy cards and/or digital wallets, or physical product distribution. In one embodiment for physical product distribution, an “anonymous drop-off point”, such as a convenience store or other ubiquitous location is used. In another embodiment, a “package distribution kiosk” may be used that allows the user to retrieve the package from the kiosk in a secure fashion. However, in one embodiment, the user may use PTD 570 to change the shipping address of the product at any time during the distribution cycle.

One embodiment of privacy card 605 is illustrated in FIG. 3. In one embodiment, privacy card 605 is configured to be the size of a credit card. Privacy card 605 includes processor 610, memory 615 and input/output logic 620. Processor 610 is configured to execute instructions to perform the functionality herein. The instructions may be stored in memory 615. Memory 615 is also configured to store data, such as transaction data and the like. In one embodiment, memory 615 stores the transaction ID used to perform transactions in accordance with the teachings of the present invention. Alternately, the processor may be replaced with specially configured logic to perform the functions described here.

Input/output logic 620 is configured to enable privacy card 605 to send and receive information. In one embodiment, input/output logic 620 is configured to communicate through a wired or contact connection. In another embodiment, input/output logic 620 is configured to communicate through a wireless or contactless connection. A variety of communication technologies may be used.

In one embodiment, display 625 is used to generate bar codes scanable by coupled devices and used to perform processes as described herein. Privacy card 605 may also include magnetic stripe generator 640 to simulate a magnetic stripe readable by devices such as legacy POS terminals.

In one embodiment, biometric information, such as fingerprint recognition, is used as a security mechanism that limits access to privacy card 605 to authorized users. A fingerprint touch pad and associated logic 630 is therefore included in one embodiment to perform these functions. Alternately, security may be achieved using a smart card chip interface 650, which uses known smart card technology to perform the function.

Memory 615 can have transaction history storage area. The transaction history storage area stores transaction records (electronic receipts) that are received from POS terminals. The ways for the data to be input to the card include wireless communications and the smart card chip interface which functions similar to existing smart card interfaces. Both of these approaches presume that the POS terminal is equipped with the corresponding interface and can therefore transmit the data to the card.

Memory 615 can also have user identity/account information block. The user identity/account information block stores data about the user and accounts that are accessed by the card. The type of data stored includes the meta account information used to identify the account to be used.

One embodiment of a digital wallet 705 is illustrated in FIG. 4. Digital wallet 705 includes coupling peripheral port 710 for privacy card 605, processor 715, memory 720, input/output logic 725, display 730 and peripheral port 735. Processor 715 is configured to execute instructions, such as those stored in memory 720, to perform the functionality described herein. Memory 720 may also store data including financial information, eCoupons, shopping lists and the like. The digital wallet may be configured to have additional storage. In one embodiment, the additional storage is in a form of a card that couples to the device through peripheral port 710.

In one embodiment, privacy card 605 couples to digital wallet 705 through peripheral port 710; however, privacy card 605 may also couple to digital wallet 705 through another form of connection including a wireless connection.

Input/output logic 725 provides the mechanism for the digital wallet 705 to communicate information. In one embodiment, the input/output logic 725 provides data to a POS terminal or to privacy card 605 in a pre-specified format. The data may be output through a wired or wireless connection.

Digital wallet 705 may also include display 730 for display of status information to the user. Display 730 may also provide requests for input and may be a touch sensitive display, enabling the user to provide the input through the display.

The physical manifestation of many of the technologies in digital wallet 705 will likely be different from those in privacy card 605, mainly because of the availability of physical real estate in which to package technology. Examples of different physical representations would include the display, fingerprint recognition unit, etc.

The components of a secure transaction system illustrated in FIGS. 2, 3, and 4 are further described in PCT published patent application No. US00/35619, which is assigned to the same assignee as the present application and that is hereby incorporated by reference.

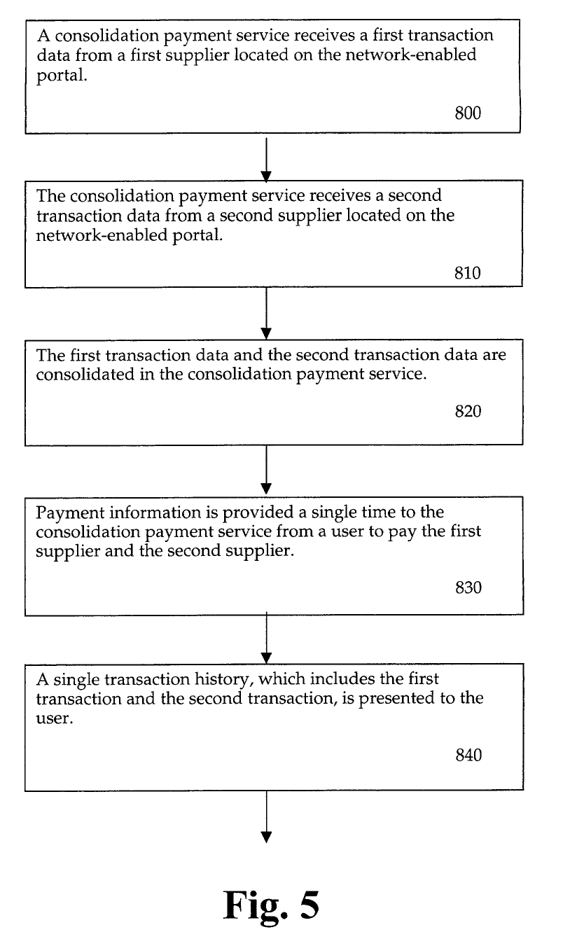

FIG. 5 is a flow diagram of one embodiment of a method that processes billing information and pays bills of different networked suppliers. At block 800, a consolidation payment service receives a first transaction data from a first supplier located on the network-enabled portal. At block 810, the consolidation payment service receives a second transaction data from a second supplier located on the network-enabled portal. At block 820, the first transaction data and the second transaction data are consolidated in the consolidation payment service.

At block 830, payment information is provided a single time to the consolidation payment service from a user to pay the first supplier and the second supplier. At block 840, a single transaction history, which includes the first transaction and the second transaction, is presented to the user.

It will be appreciated that more or fewer processes may be incorporated into the method illustrated in FIG. 5 without departing from the scope of the invention and that no particular order is implied by the arrangement of blocks shown and described herein. It further will be appreciated that the method described in conjunction with FIG. 5 may be embodied in machine-executable instructions, e.g., software. The instructions can be used to cause a general-purpose or special-purpose processor that is programmed with the instructions to perform the operations described. Alternatively, the operations might be performed by specific hardware components that contain hardwired logic for performing the operations, or by any combination of programmed computer components and custom hardware components. The methods may be provided as a computer program product that may include a machine-readable medium having stored thereon instructions which may be used to program a computer (or other electronic devices) to perform the methods. For the purposes of this specification, the terms “machine-readable medium” shall be taken to include any medium that is capable of storing or encoding a sequence of instructions for execution by the machine and that cause the machine to perform any one of the methodologies of the present invention. The term “machine-readable medium” shall accordingly be taken to include, but not be limited to, solid-state memories, optical and magnetic disks, and carrier wave signals. Furthermore, it is common in the art to speak of software, in one form or another (e.g., program, procedure, process, application, module, logic . . . ), as taking an action or causing a result. Such expressions are merely a shorthand way of saying that execution of the software by a computer causes the processor of the computer to perform an action or a produce a result.

In the preceding detailed description, the invention is described with reference to specific embodiments thereof. It will, however, be evident that various modifications and changes may be made thereto without departing from the broader spirit and scope of the invention as set forth in the claims. The specification and drawings are, accordingly, to be regarded in an illustrative rather than a restrictive sense.

What is claimed is:

1. A method for consolidating transaction data from more than one supplier over a network-enabled portal, and paying the suppliers by having payment information provided a single time from a user, the method comprising:
receiving at a consolidation payment service a first transaction data from a first supplier located on the network-enabled portal;
receiving at the consolidation payment service a second transaction data from a second supplier located on the network-enabled portal;
consolidating at the consolidation payment service the first transaction data and the second transaction data;
receiving at the consolidation payment service payment information a single time from the user to pay the first supplier and the second supplier; and
presenting to the user a single transaction history which includes the first transaction data and the second transaction data.

2. The method of claim 1, further comprising:
accessing a first digital payment right policy associated with a first product, purchased from the first supplier, which determines a payment to one of an author, a singer, and an owner of the first product.

3. The method of claim 2, further comprising:
paying through the consolidation payment service one of the author, the singer, and the owner of the product.

4. The method of claim 1, further comprising:
authorizing a first transaction with the first supplier and a second transaction with the second supplier using a transaction device configured to compare a first biometric data stored in the transaction device to a second biometric data sensed from a person.

5. The method of claim 1, further comprising:
allowing the user to remain anonymous during transactions with one of the first supplier and the second supplier.

6. A computer-implemented method comprising:
consolidating a first transaction and a second transaction in a consolidation payment service from a first supplier and a second supplier located on a network-enabled portal; and
receiving at the consolidation payment service payment information a single time, the consolidation payment service configured to partition a payment to the first supplier and the second supplier.

7. The computer-implemented method of claim 6, further comprising:
using a transaction privacy clearinghouse in the first transaction and the second transaction which prevents disclosure of an identity of a user to the first supplier and the second supplier.

8. The computer-implemented method of claim 7, further comprising:
presenting to a user a single transaction history which includes the first transaction and the second transaction.

9. The computer-implemented method of claim 6, further comprising:
accessing a first digital payment right associated with a first product associated with the first transaction which determines a payment to one of an author, a singer, and an owner of the first product.

10. The computer-implemented method of claim 9, further comprising:
paying one of the author, the singer, and the owner of the product through the consolidation payment service.

11. The computer-implemented method of claim 6, further comprising:
authorizing a first transaction and a second transaction using a transaction device configured to compare a first biometric data stored on the transaction device to a second biometric data sensed from a person.

12. The computer-implemented method of claim 10, further comprising:
partitioning money to the first supplier and the second supplier according to a first transaction amount associated with the first transaction and a second transaction amount associated with the second transaction.

13. The computer-implemented method of claim 12, further comprising:
partitioning taxes to the first supplier and the second supplier according to a first transaction amount associated with the first transaction and a second transaction a mount associated with the second transaction.

14. An apparatus comprising:
a transaction terminal adapted to receive a transaction device, the transaction device configured to authorize a transaction by processing biometric information from a user;
the transaction terminal selectively coupled to a processor having stored therein instructions which when executed by the processor cause the processor to generate data and to:
(a) consolidate in a consolidation payment service a first transaction data from a first supplier on a network-enabled portal and a second transaction on the network-enabled portal configured to allow the user to pay for the first transaction and the second transaction by providing payment information a single time to the consolidation payment service;
(b) use a transaction privacy clearinghouse, coupled to the consolidation payment service, in the first transaction and the second transaction which prevents disclosure of an identity of the user to the first supplier and the second supplier; and
(c) present to the user a single transaction history which includes the first transaction and the second transaction.

15. The apparatus of claim 14, further comprising instructions which when executed by the processor cause the processor to:
(d) access a first digital payment right policy associated with the first product which determines a payment to one of an author, a singer, and an owner of the product.

16. The apparatus of claim 13, further comprising instructions which when executed by the processor cause the processor to:
(e) pay one of the author, the singer, and the owner of the product through the consolidation payment service.

17. The apparatus of claim 13, further comprising:
(f) collect and pay taxes through the consolidation payment service.

18. A machine readable storage media containing executable program instructions which when executed cause a digital processing system to perform a method comprising:
consolidating in a consolidation payment service a first transaction data and a second transaction data;
receiving at the consolidation payment service payment information a single time from a user to pay for the first transaction and the second transaction;
maintaining the anonymity of a user during a purchase of one of a product and a service from one of the first supplier and the second supplier; and
presenting to the user a single transaction history which includes the first transaction and the second transaction.

19. The machine readable storage media of claim 18, wherein the method further comprises:
accessing a first digital payment right policy associated with the first product which determines a payment to one of an author, a singer, and an owner of the first product.

20. The machine readable storage media of claim 18, wherein the method further comprises:
paying through the payment consolidation service one of the author, the singer, and the owner of the product.

21. The machine readable storage media of claim 18, wherein the method further comprises:
paying through the payment consolidation service one of the author, the singer, and the owner of the product.
